(19) United States
(12) Patent Application Publication
(10) Pub. No.: US 2021/0261071 A1
(43) Pub. Date: Aug. 26, 2021

(54) MODULAR ARRANGEMENT

(71) Applicant: Hutchinson, Paris (FR)

(72) Inventors: Fabrice Chopard, Saint-Martin-d'Hères (FR); Cédric Huillet, Montargis (FR)

(21) Appl. No.: 17/316,084

(22) Filed: May 10, 2021

Related U.S. Application Data
(63) Continuation-in-part of application No. 15/753,861, filed on Feb. 20, 2018.

(30) Foreign Application Priority Data
Aug. 20, 2015 (FR) 1557834

(51) Int. Cl. B60R 13/08; B62D 25/06; B60R 13/02; B64C 1/40; B32B 5/18; B32B 5/02; B32B 5/32; B32B 7/12

(52) U.S. Cl. CPC B60R 13/08; B62D 25/06; B60R 13/0218; B60R 13/0243; B64C 1/40; B32B 2307/102; B32B 5/02; B32B 5/32; B32B 7/12; B32B 2605/00; B32B 2307/304; B32B 5/18

(57) ABSTRACT

A vehicle having a passenger cabin to be maintained within a temperature range, the vehicle comprising a vehicle body and an assembly defining the passenger cabin, the assembly including:
a structural lining panel having a surface and being non-planar,
fixation means for attaching the structural lining panel to the vehicle body, and
a modular assembly including a plurality of side-by-side modules, each module extending in a non-planar surface and including:
   an under vacuum envelope and,
   a layer of a thermally insulating material, the side-by-side modules being arranged side by side in a direction parallel to the surface of the structural lining panel.
      The side-by-side modules are joined to said structural lining panel while being joined to said vehicle body only by said fixation means.

### CROSS REFERENCE TO RELATED APPLICATIONS

This application is a Continuation-In-Part of U.S. application Ser. No. 15/753,861, filed Feb. 20, 2018, which is a national phase of PCT/FR2016/052093, filed Aug. 19, 2016, which claims priority to French Application No. 1557834, filed Aug. 20, 2015, the subject matter of each of which are incorporated by reference herein in their entirety.

### BACKGROUND OF THE INVENTION

The present invention relates to managing comfort in a passenger cabin of a vehicle.

In that field, the present invention relates to an arrangement comprising at least one module comprising a thermal insulating material, preferably porous, which thermal insulating material is disposed in a volume under vacuum, often referred to as a VIP (vacuum insulating panel).

A VIP can be used to improve performance in expected thermal management and/or reduce the overall thickness of the thermal insulation material compared to another thermal insulation material.

A passenger cabin may be a compartment of any terrestrial, sea or aeronautical (flying) vehicle in which someone may enter by using a door which opens or closes an access to the compartment. Accordingly, a so-called door may be a door of a car, a boat or an aeronef. Below, a roof may be a roof of any of such vehicles or may consist in a fuselage of any of such vehicles. Roof and fuselage will then be one and the same word.

“Porous” means that the material has interstitial spaces that allow the passage of air. Open-cell porous materials therefore include foams, as well as fibrous materials (such as glass wool or rock wool), and powder. To ensure good thermal insulation, the interstitial spaces to be called pores are of the order of less than 1 or 2 mm, preferably less than 1 micron, preferably even less than 10⁻⁹ m (nanoporous structure), especially when aging resistance and thus possible lower negative pressure conditions in the VIP envelope are concerned.

“VIP” means an element under partial air vacuum (where the internal pressure can be between 10² Pa and less than 10⁵ Pa) containing a (preferably porous) thermal insulation material (pore sizes less than 10 microns). However, it should be noted that the term air “vacuum” includes the case where this partial vacuum is replaced by a “controlled atmosphere”: The insulating pockets are filled with a gas that has a lower thermal conductivity than the ambient air (26 mW/m.K).

To be “thermal(ly) insulating”, the material must have a thermal conductivity (A) less than or equal to 50 mW/m.K.

VIP panels are typically thermal insulations in which cores of porous material, such as silica gel or silica powder (SiO2), are pressed into a sheet and each is surrounded by a gas-tight wrapping film, such as plastic and/or roll-formed aluminum, under partial vacuum.

A problem that exists with modules that individually contain a thermally insulating material placed in a volume under vacuum may relate to how their structural environment is defined and how the modules are designed and placed in that structural environment. A solution, called solution a), is as follows:
a) a vehicle having a passenger cabin, the vehicle comprising a vehicle body part and, interposed between the passenger cabin and the vehicle body part:
a structural lining panel which is inwardly lining said part of the vehicle body, the structural lining panel having a outward non-planar surface and containing at least one of a polymer material and a natural material, fixation means to fasten the structural lining panel to said part of the vehicle body; and
a module set comprising a plurality of modules, each module extending in a non-planar surface and being interposed between the vehicle body part and the structural lining panel, each module comprising:
   an airtight envelope and, enclosed under vacuum within the airtight envelope:
   a layer comprising a thermally insulating material, the modules being arranged in a direction oriented according to the non-planar surface of the structural lining panel or an inward non-planar surface of the vehicle body part,
      said module set being directly fastened to one of the structural lining panel and said vehicle body part, only.

As it will be noted in the following, a module, or a module set, may comprise element(s), and especially layer(s), other than a thermally temperature control element insulating material, such as an adhesive layer, a soundproofing layer, a temperature control element.

Thus, an industrial design corresponding to a mass production may be reached. And comfort is managed by efficiently managing temperature.

A first element, which is “lining” a second element, extends, outside said second element, along one side of the second element. The outside surface of the second element is not completely surrounded by the first “lining element”.

“Only” means “exclusively”, which also means that each module is not fastened directly to the other one of said structural lining panel and vehicle body. Each module is then indirectly fastened to said other one of said structural lining panel and vehicle body, via the fixation means.

In other words:
the structural lining panel is (possibly directly) fastened to the vehicle body, via the fixation means,
if the or each module is directly fastened to the vehicle body, said module is not directly fastened to the structural lining panel; however it is indirectly fastened to said structural lining panel, since the fixation means fasten the structural lining panel to the vehicle body.

Possibly, such an “indirect fastening to the other one of said structural lining panel and vehicle body” may be made via said fixation means, only.

This would limit the risks of hyperstatism, the number of fixation means, the time reserved for assembling the elements concerned and the risk of puncturing the envelope of the module.

First and second elements or members «directly fastened (to each other)» means: using a fastening witch engage both the first and second elements or members. First and second elements or members indirectly fastened to each other means these first and second elements or members are fastened together by means of a third element or member. For example, above, a so-called module (first element) would be (directly) fastened to the structural lining panel (second element) while being indirectly fastened to the vehicle body, via (at least or only) the so-called fixation means which (directly) fasten the structural lining panel to the vehicle body.

In the present specification, the term «fasten» with no expression «direct(ly)» or «indirect(ly)» means the fastening may be indifferently direct or indirect.

The direct fastening of any so-called module and either the vehicle body part of the structural lining panel will be:
either a chemical bonding (such as fusing or gluing),
a mechanical fastening (such as screws, pins, clips, or a hook-and-loop fastener system, often called “Velcro system”™).

If the airtight envelope is not a metal thin plate, and if a chemical bonding is used, the chemical bonding will preferably be an adhesive bonding.

If so, the airtight envelope of a module will preferably be further so adhesively bonded:
either by means of a sticky joint (see below),
or by means of an adhesive layer covering at least 50% of the surface of the airtight envelope, on the side of the airtight envelope to be fasten.

Both means are valuable in terms of vibration absorbing.

As examples, the airtight envelope may consist of at least one thin metal sheet (preferably between 0.06 mm and 0.5 mm) or an all-plastic film or a composite film, or a composite film comprising a plastic layer and a thin metal layer, dozen of nanometer to dozen of micrometer, may be 80 nm to 8 microns.

Typically, a thermal conductivity (λ) of each module less than or equal to 0.01 W/m.K can be expected here.

In this specification, internal(ly), inner and inward(ly) are synomisms, the same for external(ly), outer and outward(ly).

As a consequence, and for example:
the structural lining panel is arranged inwardly with respect to the part of the vehicle body that the structural lining panel is inwardly lining,
an outward skin panel (see below), also known as an outer skin panel, is defining an external shape of the vehicle.

A structural lining panel (which might also be called a structure plate) is a solid plate (or panel) containing at least one of a polymer material and a natural material, which means the structural lining panel may be made of a composite material.

Examples include:
a thermoplastic Olefin (TPO) plastic sheet made of bioplastic which is made of biomass,
material produced from renewable raw materials, and
Natural-Fibre Composites (NFC) made through the combination of natural fibres with different polymers such as Polypropylene (PP).

A natural material may include jute fibers or all types of fibres that occur within nature, and are found in vegetables respectively plants (cellulose fibres), animals (protein fibres) and minerals (asbestos).

“Containing a polymer material or a natural material ” means that the structural lining panel may be, at least essentially, made of solid plastic or a solid (compressed) natural component or a solid composite material (see below).

At the location where it is arranged, the structural lining panel will bound (which means limit) the passenger cabin.

Since a vehicle body may be thermally exposed to an external environment in which the vehicle is located and in which sun may shine hard or ice may cover the vehicle body, having an efficient and light thermally insulating device is useful to both improve the comfort of a passenger and prevent an excessive use of an AC system of the vehicle.

Two parts of a vehicle body can especially be provided with the solution of the invention: the roof part and a door part of the vehicle.

However at least for the roof part, the so-called module(s) may be arranged inwardly or outwardly with respect to the structural lining panel.

As a consequence, and as alternatives to each other and to solution a), the invention also concerns the options b) and c) as follows:
b) a vehicle having a passenger cabin and comprising:
a part of a vehicle body including an outward skin panel outlining an external shape of the vehicle and,
a structural lining panel inwardly lining the outward skin panel and containing at least one of a polymer material and a natural material, the structural lining panel having a non-planar surface,
fixation means to directly fasten the structural lining panel to the vehicle body part,
a module set including at least one module extending in a non-planar surface, the at least one module comprising:
   an airtight envelope and, enclosed under vacuum within the airtight envelope:
   a layer comprising a thermally insulating material,
wherein said module set is directly fastened to said structural lining panel, and,
wherein said module set is further indirectly fastened to said vehicle body part, via said fixation means; or
c) a vehicle having a passenger cabin and comprising:
a part of a vehicle body including an outward skin panel outlining an external shape of the vehicle, the vehicle body part having an inward non-planar surface,
a structural lining panel which is inwardly lining the outward skin panel, the structural lining panel containing at least one of a polymer material and a natural material, and having a outward non-planar surface,
fixation means to fasten the structural lining panel to the vehicle body part, a module extending in a non-planar surface, the module comprising:
   an airtight envelope and, enclosed under vacuum within the airtight envelope:
   a layer comprising a thermally insulating material, and,
wherein said module is arranged between the structural lining panel and the outward skin panel, and
wherein said module is directly fastened to the vehicle body part, only.

Preferably, the module or module set is directly fastened to no other element except said one of the structural lining panel and the vehicle body part.

Especially if the above-mentioned part of the vehicle body is a roof or a door of the vehicle, a problem may further arise in relation to how and where preferably arranging the module(s).

In such respective situations, it is proposed what follows:
d) for the roof:
the outward skin panel will be a part of a roof unit of the vehicle having a non-planar surface,
the roof unit will further include a front cross member, a rear cross member, and longitudinal frame members delimiting a frame covered by the roof outward skin panel, the frame having a non-planar surface,
the structural lining panel will be lining the front cross member, rear cross member, and longitudinal frame members,
said module will be directly fastened to at least one of the front cross member, the rear cross member, the longitudinal frame members and the outward skin panel part, and,
the non-planar surface of said module will fit with a part of the non-planar surface of at least one of the roof frame and the outward skin panel part; or:
   e) for the door:
the outward skin panel will be a part of a door unit of the vehicle,
the door unit will further include a frame part having an inward non-planar surface and which is covered outwardly by the outward skin panel and inwardly by the structural lining,
said module will be directly fastened to the door frame, and,
the non-planar surface of said module will fit with a part of the inward non-planar surface of frame part.

As explained in the beginning of the specification, any other fastening of said module or module set will then be indirect.

“Fit” means: “match” to each other.

To form the roof unit, the roof outward skin panel and the roof frame may be welded or adhesively bonded together. They may be glued.

To form the door unit, the door outward skin panel and the door frame may be welded or adhesively bonded together. They may be glued.

A 3D printing, any other one-piece manufacturing of the door unit or the roof unit may not be excluded.

Even if the direct fastening of the module or module set is essential, a foam layer, a felt layer or a soundproofing layer may cover the airtight envelope, for a mechanical protection of the airtight envelope and/or a limitation of vibrations and/or an acoustic effect.

On that matter, it is more precisely proposed that:
said module further includes one of a foam layer, a felt layer and a soundproofing layer chemically bonded with the airtight envelope, so that said one of the foam layer, the felt layer and the soundproofing layer is interposed between the airtight envelope and said vehicle body part, and, wherein said direct fastening of the module is a chemical bonding between:
   said one of the foam layer, the felt layer and the soundproofing layer, and
   at least one of the roof frame and the roof outward skin panel; or
said module further includes one of a foam layer, a felt layer and a soundproofing layer chemically bonded with the airtight envelope, so that said one of the foam layer, the felt layer and the soundproofing layer is interposed between the airtight envelope said door frame, and,
wherein said direct fastening of the module is a chemically bonding between:
   said one of the foam layer, the felt layer and the soundproofing layer, and
   the door frame.

The way to directly connecting a so-called module to a part of the vehicle body has also be especially addressed, in connection with a mass production.

A layer will be considered as a soundproofing layer if including a porous material, such as a foam, wool, fibrous material, having a density over 6 Kg/m³, and preferably equal or over 30 Kg/m³, and a thickness between 2 and 20 mm.

If the part of the vehicle body is a door frame having an opening passing therethrough, it is proposed that said direct fastening of the module comprises a chemical bonding between the airtight envelope and the door frame, by means of a sticky joint sticked to the airtight envelope and to the door frame, around the opening.

If one a foam layer, felt layer and soundproofing layer is used, it is proposed that said direct fastening of the module direct fastening of the module comprises:
a first adhesive layer covering a major part of the non-planar surface of the module chemical and interposed between the airtight envelope and said one of the foam layer, the felt layer and the soundproofing layer, for a chemical bonding therebetween, and
a second adhesive layer covering a major part of the foam layer, the felt layer and the soundproofing layer and interposed between the vehicle body part and said one of the foam layer, the felt layer and the soundproofing layer, for a chemical bonding therebetween.

In any of the solutions presented in this specification, providing a plurality of so-called modules, instead of one module defining a larger single unit with a single block of thermally insulating material in a single vacuum volume, and arranging such modules to each other, side by side as mentioned above, should allow a simplified manufacturing process and “direct fastening” process, accompanied by a high flexibility and a wider choice of locations where to arrange the modules.

As a consequence, it is proposed that, a so-called module set comprises a plurality of modules:
each module extending in a non-planar surface,
the modules being arranged in a direction oriented according to the non-planar surface of the structural lining panel or of the vehicle body part, and,
at least some of the modules being arranged side by side.

“Side by side” means that the modules are not arranged one above the other, but commonly arranged in a direction oriented according to (which means more or less parallel to) the surface of the structural lining panel or the vehicle body part along which they extend, depending on which one is “lined”. If a plurality of side by side modules are used, they may be either adjacent or spaced apart, with a distance therebetween.

Anyway using a plurality of modules will limit the risk of a dramatic loss of thermal efficiency, since a possible puncture of one so-called module will not affect the thermal efficiency of the others.

Thus, it might be advantageous to consider the use of any of the present solutions in a vehicle,
wherein a module set includes a plurality of said modules arranged side by side in a direction oriented according to the non-planar surface of the structural lining panel or of the vehicle body part, and/or,
wherein the non-planar surfaces of a plurality of said modules individually fit with said non-planar surface of the structural lining panel or of the vehicle body part.

Such a fitting with smaller modules should be easier to reach.

Preferably, for a so-called fastening between the structural lining panel and a plurality of modules arranged side by side as above:
the structural lining panel and the modules may be made of respective thermoplastically deformable material, possibly integrated into one piece, and,
the structural lining panel and the modules have respective non-planar shapes that fit together.

Both the structural lining panel and the modules will advantageously be hot formable.

Considering any of a so-called module:
the airtight envelope may be (at least partially) made of a thin heat-deformable thermoplastic film (such as mainly PE and/or PET) having a thickness of less than 200 μm, preferably less than 100 μm, instead of a sheet made of (entirely or at least substantially) metal,
the total thickness of a module is preferably less than 8 mm and more preferably less than or equal to 6 mm, and for the best less than or equal to 4 mm.

Fusing (by chemical fastening, such as via gluing or melting) the plastic of the film(s) and a plastic or composite material of a structural lining panel should be an efficient way to both:
achieve a tight, non-planar interlock between the structural lining panel and the module(s), as well as
fasten the structural lining panel and the module(s) together.

Alternatives for an improved connection between a structural lining panel and a module, it is proposed that:
the module has hermetically sealed perforations through the airtight envelope and the layer of thermal insulation material,
the fasteners include pins fixed to the structural lining panel and passing through the hermetically sealed perforations, and
the pins have a free end provided with edges that are pressed outward against the module to hold the module in place.

This is possible because of the relative resilence of the module.

This resilence may also be useful in terms of how the module and structural lining panel are joined together.

In the following options, it is preferably provided that:
the thickness of each module is preferably less than 8 mm and even further preferably less than or equal to 6 mm or 4 mm, and
both the structural lining panel and the modules are hot formable, and
the structural lining panel is preferably made of a thermoplastic solid plastic or composite material (i.e., a matrix and a filler, such as fibers, that do not interfere with hot deformation).

In any case, the thickness of the structural lining panel will preferably be less than 20 mm and even further preferably less than or equal to 10 mm.

A liner, called lining as well, may cover the structural lining panel.

Such a liner would cover the inward surface of the structural lining panel, viz. the surface oriented towards the passenger cabin.

Further, in such a case, the module or the side-by-side modules might consequently be interposed, without risks, between the liner and the polymer structural lining panel.

The liner may be mechanically resistant to protect the module or the side-by-side modules against puncture of the envelope(s) and break of vacuum. The standard EN 14477 or ASTM F 1306 may be requested.

Another solution is to make the envelope material as at least one thin metal wall.

If not interposed as above, the module or the side-by-side modules may be arranged so that the polymer structural lining panel is interposed between the liner and the module(s).

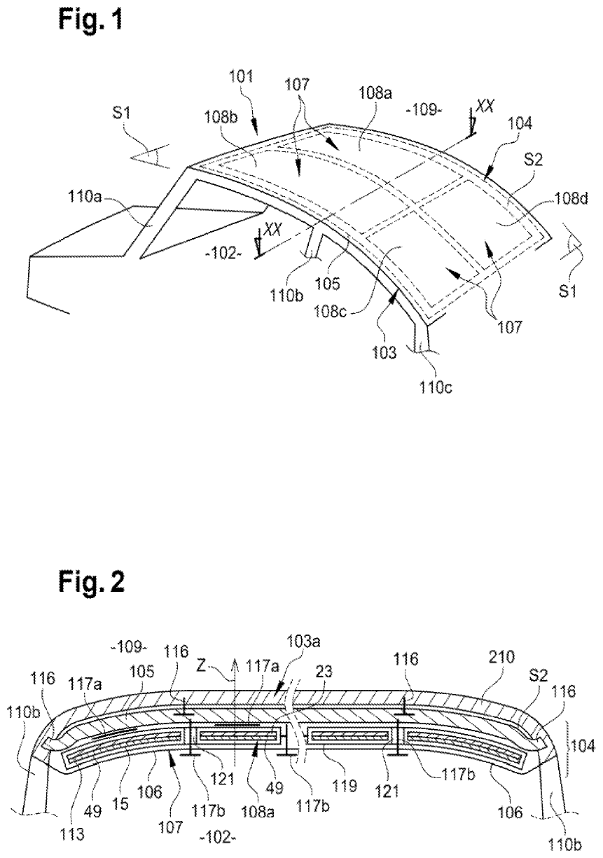

In such a case, theor each module is protected against puncture of the envelope(s) and break of vacuum by the mechanically resistant structural lining panel (see notably the embodiment in relation to FIGS. 1,2,4,7 below).

To improve the thermal management of the assembly without compromising the above advantages, it is also proposed that any so-called module additionally comprises a layer including a thermal phase change material (also called PCM), such as a polymer matrix in which at least one PCM is dispersed and which is overlaid with the module or at least the layer containing the thermal insulating material.

As a PCM may be used a rubber composition as described in EP2690137 or in EP2690141, namely, in the second case, of a crosslinked composition based on at least one “STR” silicone elastomer vulcanized at room temperature and containing at least one PCM, the at least one silicone elastomer having a viscosity, measured at 23° C. according to ISO 3219, of at most 5000 mPa·s.

As additional features to be considered independently or in any combination, the following is to be noted, as well:
in the vehicle:
   each module may usefully have hermetically sealed perforations passing through the airtight envelope and the layer comprising the heat insulating material,
   the fixation means may usefully include pins fastened to the structural lining panel and passing through the hermetically sealed perforations, and
   said pins may usefully have a free end provided with edges that are outwardly applied against one of said modules to retain the module;
in the vehicle:
   the structural lining panel and the modules may usefully be made of respective thermoplastically formable materials, and
   said modules may usefully individually fit with the non-planar shape of the structural lining panel or the vehicle body part;
   in the vehicle, said direct fastening of the module set includes at least one of a mechanical bonding and an adhesive bonding.

If necessary, the invention will be better understood and other features, details and advantages thereof will be appreciated upon reading the following description as non-exhaustive examples with reference to the accompanying drawings, wherein:

FIG. 1 shows schematically a motor vehicle roof with PIV modules as proposed in the invention,

FIG. 2 is a section along the line II-II of FIG. 1,

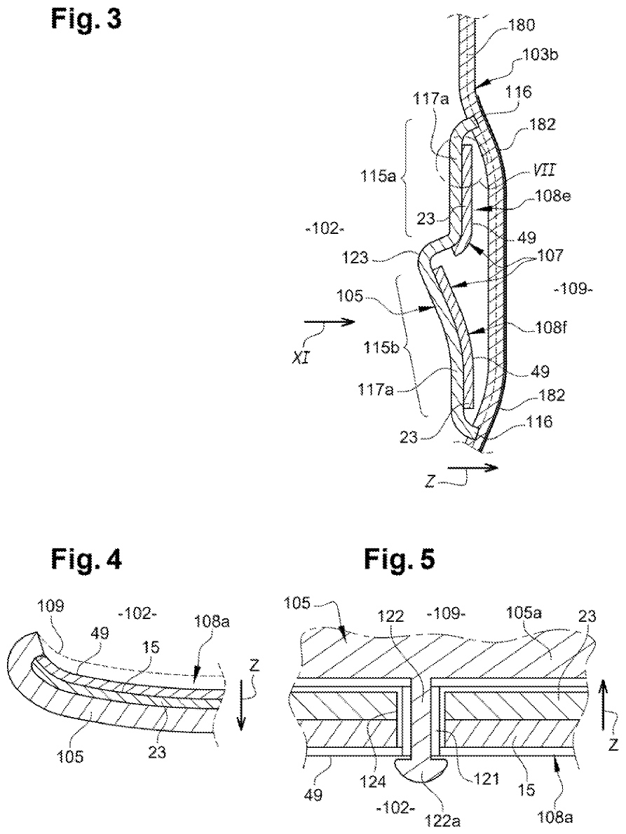

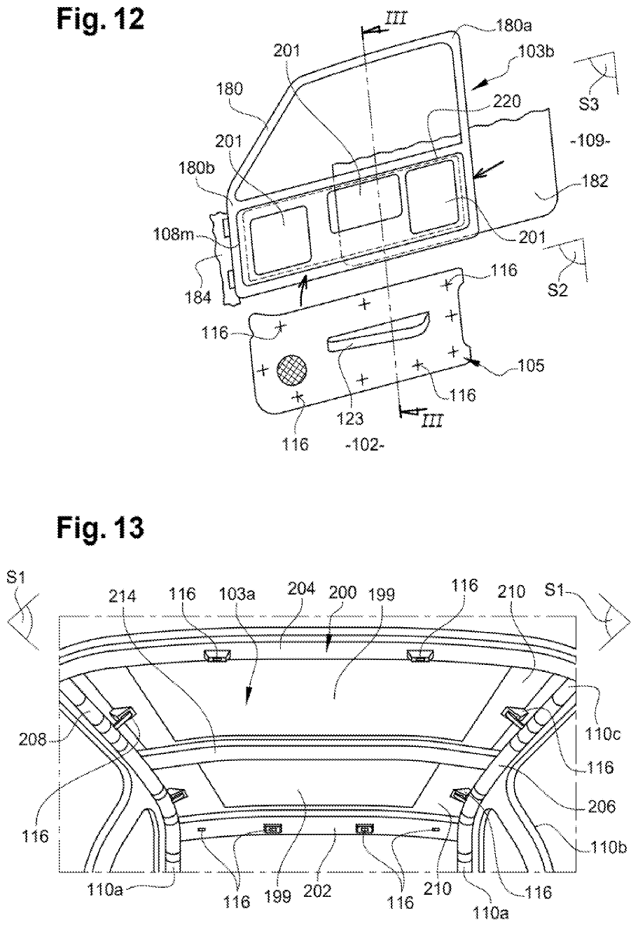

FIG. 3 is a schematic section through a motor vehicle door with PIV modules as proposed in the invention and may correspond to the section III-III of FIG. 12, when the elements are assembled;

FIG. 4 is a schematic section through a structural lining panel lined by one of the side-by-side PIV modules as proposed in the invention and integrated with the structural lining panel,

FIG. 5 is a schematic section through a structural lining panel lined by one of the side-by-side modules as proposed in the invention and fastened to the structural panel by a pin passing through an airtight hole,

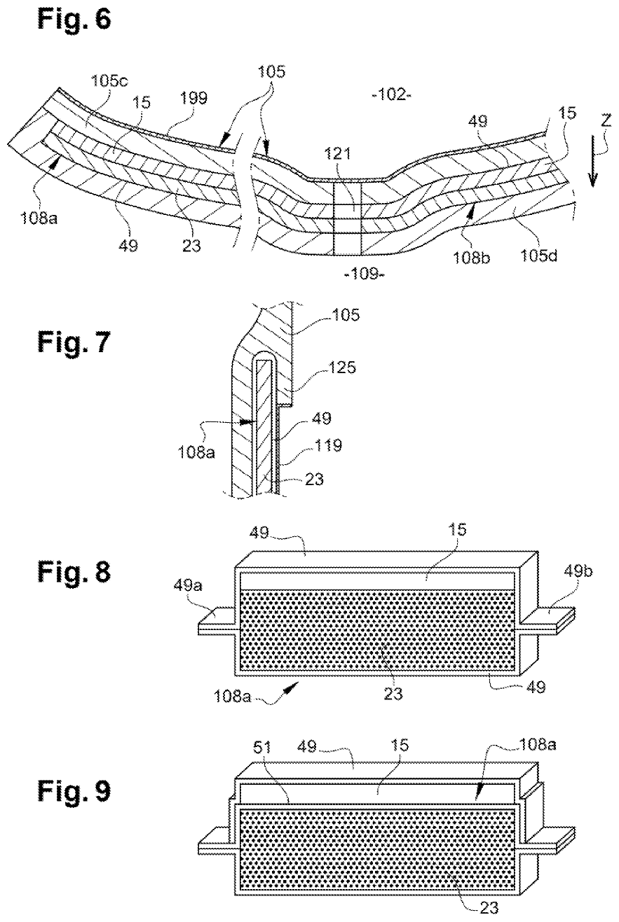

FIG. 6 is a schematic section through a structural panel in which side by side PIV modules as proposed in the invention are embedded, and,

FIG. 7 is a schematic section of detail VII in FIG. 3,

FIG. 8 and FIG. 9 are embodiments of sections of a VIP with a single and a double wrap, respectively,

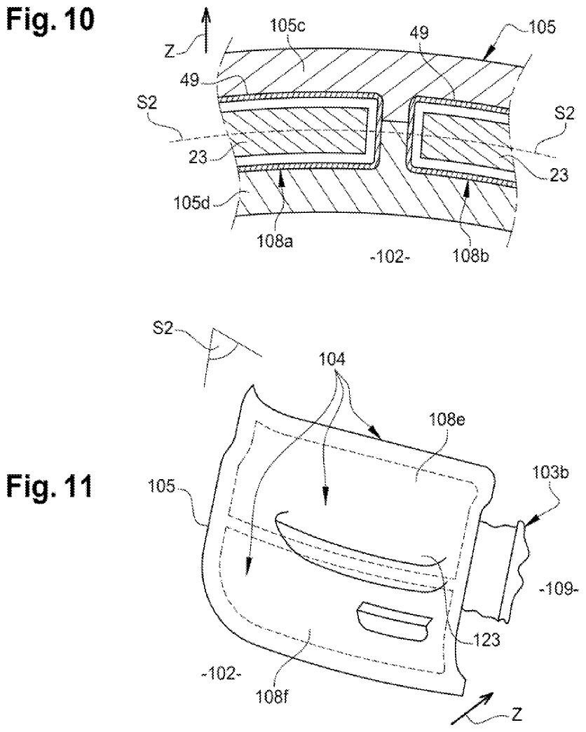

FIG. 10 is a section focusing on the side-by-side arrangement of two side-by-side modules, in one example,

FIG. 11 is a schematic perspective view and exploded view in the direction XI of FIG. 3,

FIG. 12 is a schematic perspective exploded view of a door unit inwardly lined by a so-called arrangement,

FIG. 13 is a schematic perspective view from below of a roof unit, not yet inwardly covered by a so-called arrangement,

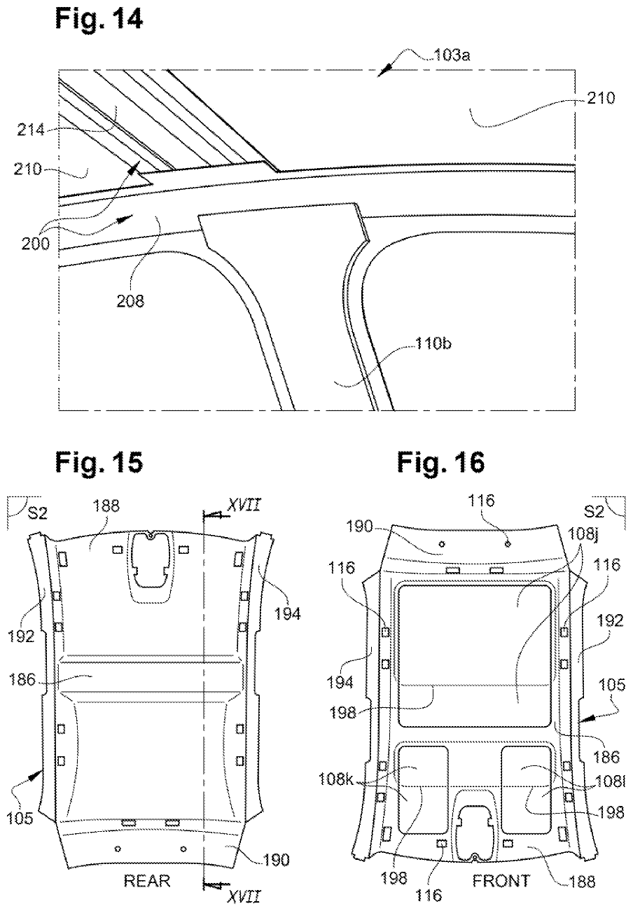

FIG. 14 is a schematic perspective view from one inward side of a part of a vehicle body, not yet inwardly covered by a so-called arrangement,

FIG. 15 is a schematic view from below of an embodiment of a so-called structural lining panel,

FIG. 16 is a schematic view from above of an embodiment of a so-called structural lining panel of FIG. 15,

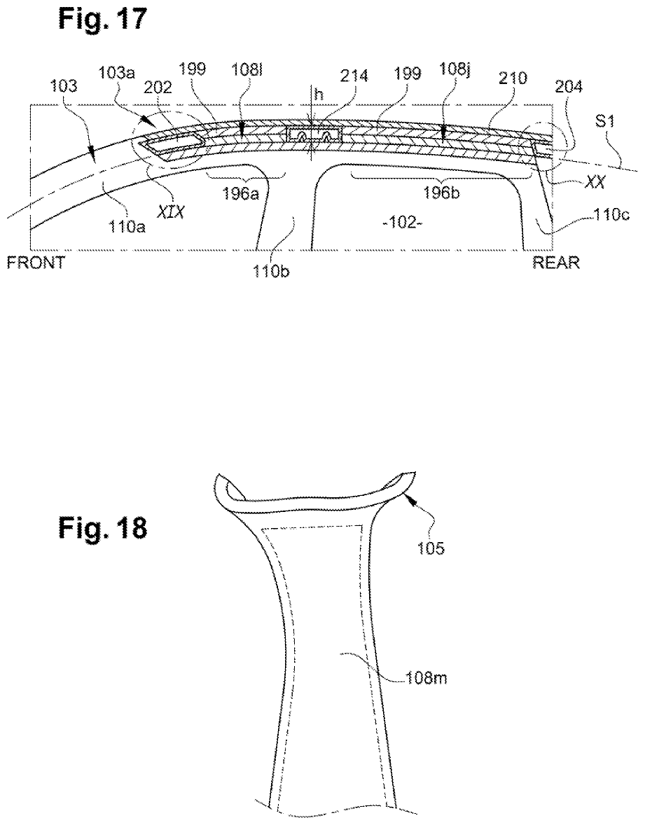

FIG. 17 is a schematic side view a part of a vehicle body, the roof unit of which is covered with a so-called arrangement; FIG. 17 illustrates a so-called arrangement which may substantially correspond to the section XVII-XVII of FIG. 17,

FIG. 18 is a schematic perspective view of a so-called arrangement adapted for inwardly covering the middle door post of the vehicle body part illustrated in FIG. 14,

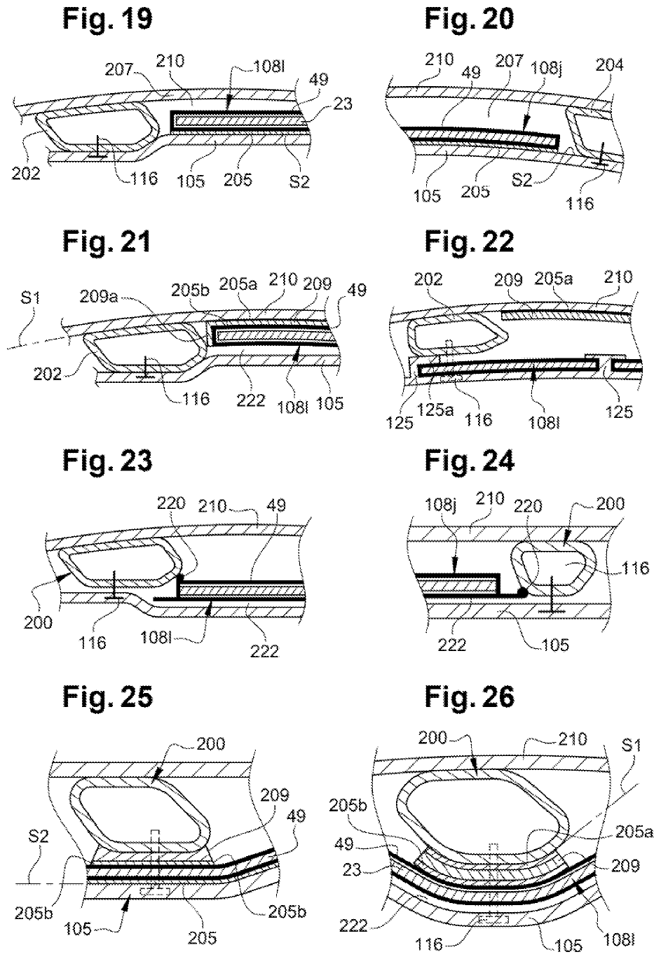

FIGS. 19 to 26 are schematic vertical sections of various embodiments of a roof unit inwardly lined by a so-called arrangement; FIG. 19 may correspond to the detail XIX of FIG. 17 and FIG. 20 may correspond to the detail XX of FIG. 17,

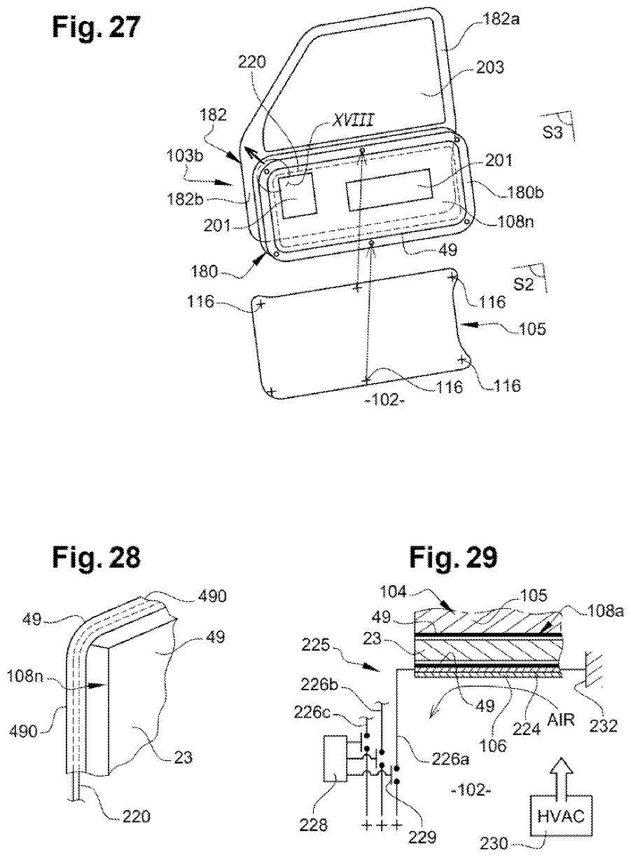

FIG. 27 is a schematic perspective exploded view of another embodiment of a door unit inwardly lined by a so-called arrangement,

FIG. 28 illustrates the detail XVIII of FIG. 27, viz. a module provided with a sticky joint,

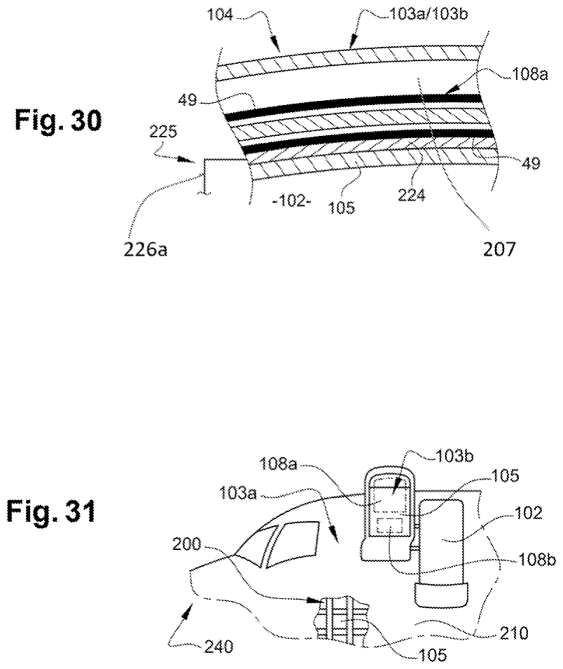

FIGS. 29 and 30 each illustrates an environment of a passenger compartment including a cladding shown through a schematic and partial sectional view, and provided with a temperature control device, and

FIG. 31 is a schematic view of an aircraft to which any of the present solutions may be applied.

In what follows, reference is made to a vehicle having a vehicle body (which might be called bodywork as well) a relatively broad surface of which has to be inwardly covered with at least one element comprising at least one thermal insulation material contained in a vacuum volume, i.e. a VIP.

This may be the case when a passenger cabin of a motor vehicle or an aircraft, even a ship, is to be kept within a temperature range.

FIGS. 1 and 2 show a vehicle roof 100 provided with a solution to this problem according to the invention.

The vehicle 101 comprises a passenger cabin 102 to be maintained within a temperature range.

The vehicle 101 includes a vehicle body 103 and an arrangement 104, called inward cladding as well, bounding the passenger cabin 102.

The vehicle body 103 may be made of metal or a composite material, such as a thermoset plastic reinforced with fibers.

The vehicle body 103 includes a roof unit 103a having a non-planar surface S1.

The roof unit 103a comprises a ceiling, called roof outward skin panel as well, 210 which extends above the passenger cabin 102 and may typically be laterally welded to the door posts of the vehicle body, known as «side wall columns» or “pillars” as well.

The arrangement 104 comprises:
a structural lining panel 105 having a non-planar surface S2 (dashed perimeter in FIG. 1) that is connected to the vehicle body 103,
at least one so-called module, such as 108a, inwardly lining the structural lining panel 105 and fastened thereto.

A Natural fiber (NF) and polypropylene (PP) composite may be a valuable solution for manufacturing the structural lining panel 105.

To manufacture such a structural lining panel, for example in a vehicle door, only polymer (such as PP) may be used. In other cases and especially for a vehicle roof, a composite material including glass fibers and polymer is often used.

The arrangement 104 may further comprise a liner 106 inwardly lining the structural lining panel 105 and directly fastened thereto.

A module set comprising a plurality of modules, 108a to 108d, arranged side by side, may be disposed between the structural lining panel 105 and the liner 106.

In accordance with an important feature common to all the embodiments, if a plurality of side-by-side modules are used, the modules will be all arranged globally:
along the surface S2 of the structural lining panel 105 (see FIG. 3,16 or as examples),
or along the local non-planar surface S3 of the body, viz. the door unit 103b in this case (see FIG. 19,26 or 27 as examples).

To be fastened, the liner 106 may be bonded with the structural lining panel 105.

The liner 106 may advantageously be mechanically resistant to protect against puncture the modules covered by said liner.

Each module comprises:
a single envelope 49 (FIG. 2 or FIG. 8) or a double envelope 49, 51 (FIG. 9) and, enclosed under vacuum within the envelope and stacked in a direction Z oriented from the liner 106 to the structural lining panel 105:
(possibly) a layer comprising a PCM, 15,
a layer comprising a thermal, or thermally, insulating material, 23.

So, each module, such as 108a, may define a PIV layer comprising an envelope enclosing, under vacuum, a thermally insulating material 23, only.

As mentioned above (and it is true for every embodiment), each module such as 108a has a non-planar shape. The non-planar shape may be different from one of the modules to another.

To improve the self-supporting and non-planar conformation of the layer comprising the thermal insulating material 23, said material 23 may include a polymer matrix 113 in which the or each thermal phase change material is dispersed.

In the module set, the modules 108a to 108d are not stacked on top of each other, but arranged side by side in a direction oriented according to the surface S2 of the structural lining panel 105.

The surface S2 is substantially transverse to the direction Z passing through the structural lining panel 105 and the vehicle body 103 lined by the structural lining panel 105 and the modules.

The structural lining panel 105 is arranged (in the Z direction) between:
the plurality of side-by-side modules, in the example 108a to 108d, and
the vehicle body or bodywork 103, in the example the body roof.

In any motor vehicle, the surface S2 of the structural lining panel 105 is more or less a slightly curved or slightly arcuated surface along which the structural lining panel 105 extends. In a fuselage surrounding a passenger cabin of an aircraft, such a curved surface or arcuated surface is typically more arcuate.

The side-by-side modules 108a to 108d are each assembled with the structural lining panel 105 and follow its shape, on one side thereof.

The envelope 49 or 51 is an airtight envelope, except for one of them:
when one of the envelopes 49 or 51 is completely enclosed by the other one
or when the film of one of the envelopes 49 or 51 is lined (on one side) by another film that is airtight and weldable, as shown in FIG. 9.

Preferably, the envelope(s) 49 and/or 51 is(are respectively) a thermoformable film having a thickness of less than 200 μm. The structural lining panel 105 may be made of plastic, such as PE (polyethylene); PP (polypropylene), PET (polyethylene terephthalate), or a composite material, such as the aforementioned plastic, to which fibers of, for example, glass, carbon (rare), cellulose, hemp, flax . . . may be added. In vehicles, PP is often used for the structural lining panel. For the roof, it is often PP+glass fibers.

The liner 106 may be lined with an inner foam layer. Thus, a foam layer 119 may be inserted between the side-by-side modules 108a to 108d and the liner 106.

The liner may be made of fabric or a felt, but may also be mechanically resistant, as a skin cover, to protect against puncture the side-by-side modules covered by such a skin cover.

Alternatively, a part of the vehicle body 103, that is not a roof unit, may be a door unit (typically made of metal, plastic or composite), referenced 103b in FIGS. 3, 12 and 27 notably, and disposed on a lateral side of the vehicle between:
a front door post 110a and a middle door post 110b, or,
a middle door post 110b and a rear door post 110c, or
a front door post 110a and a rear door post 110c.

As illustrated FIGS. 3,12 and 26, the door unit 103b may typically include:
a solid frame or skeleton 180, and
a door outward skin panel 182.

The door outward skin panel 182 and possibly at least a part of the solid frame or skeleton 180 is/are outlining an external size and external shape of the vehicle.

Both the solid frame 180 and door outward skin panel 182 may be stamped metal, plastic, or composite or other suitable material components. They are assembled together, before fixing the arrangement 104 thereto. They may especially be welded or adhesively bonded together and define together the accent line of the door.

The solid frame or skeleton 180 will preferably be a solid one piece construction which may comprise sub-elements welded together.

Preferably, the structural lining panel 105 will be directly fastened to said solid frame 180 by mechanical connectors or other fasteners, such as 116.

The or each module will be then directly fastened:
either to the structural lining panel 105, with no direct fastening to the door unit 103b (see FIG. 3),
or to the door unit 103b, specifically the solid frame 180, with no direct fastening to the structural lining panel 105(see FIG. 12 or 27).

Anyway, once the structural lining panel 105 is directly fastened to the door unit 103b, by means of connectors or other fasteners, referenced 116, the arrangement 104 will inwardly line the door unit 103b, so as to be interposed, in the Z direction as illustrated in FIG. 3, between the door unit and the structural lining panel 105.

The arrangement 104, which is disposed between the passenger cabin 102 and the door unit, outwardly limits the interior volume to be thermally controlled, viz. the passenger cabin 102 in this example.

In this regard, FIGS. 3,11,12 and 27 clearly show that the door unit 103b is inwardly lined (viz. on its inner side facing the passenger cabin 102):
by a module set comprising one module or a plurality of juxtaposed modules, such as those referenced 108e,108f in FIGS. 3, 11, 108m in FIGS. 12 and 108n in FIG. 27, and then,
by the structural lining panel 105.

In other words, the modules, in the example 108e to 108n are each disposed between the structural lining panel 105 and the vehicle body or structure, in the example the door unit 103b.

As in any embodiment, the modules are all arranged globally along the surface S2 of the structural lining panel 105 (see FIG. 3 or 11), or the local non-planar surface S3 of the body, viz. the door unit 103b in this case (see FIG. 12 or 27).

The structural lining panel 105 has still the shape of a non-planar plate.

It may include a plurality of structural sub-panels or surfaces 115a, 115b fastened together to form a unit.

The structural lining panel 105 may be made of a hot formable material which may be a thermoplastic material.

The structural lining panel 105 may locally and inwardly form a door arm rest 123 (see FIG. 3 for an example).

Direct fixation of the structural lining panel 105 to the vehicle body 103 may be by clips, rivets, screws, anchors, or other conventional means (also referred to as fasteners), designated 116.

There will never be any interference between any fixation means 116 and any so-called module or module set: As already explained, the or each module is directly fastened independently of these fixation means 116.

As described further below, the direct fixation of any module, such as 108a through 108d, or 108e and 108f, to a structural lining panel 105 may be at least one of the following: Integration in one piece (typically via a molding process), mechanical fixation (such as pins, clips, or «Velcro system»), chemical bonding (such as fusing).

Especially, the envelope 49 or 51 may be adhesively bonded, or glued, to the structural lining panel 105.

However, integrating the structural lining panel and side-by-side modules into a one-piece molded unit might be easier to produce the arrangement 104, typically by fusing.

The lining panel 105 will then be a thermoformable structural sheet initially fabricated as a flat surface and made of a thermoformable material (see examples of such materials above), preferably having a thickness between 0.2 cm and 2 cm, and more preferably having a thickness between 0.4 cm and 1 cm.

And each module, such as 108a to 108d, will preferably be a thermoformable element made first as a flat surface and made with a thermoformable thermally insulating material 23, such as a foam of polyurethane, PET, PE, PP or a fibrous material of PET, PP, PE, preferably having a thickness between 1 mm and 8 mm and more preferably a thickness between 2 mm and 5 mm.

If the structural lining panel and the side-by-side modules are made of corresponding thermoplastic formable materials and directly fastened together, it is highly favored that the structural lining panel 105 and the side-by-side modules have corresponding non-planar shapes that match each other.

The structural lining panel 105—which is typically intended to have a globally concave surface and an opposing globally convex surface—and the respective side-by-side modules may be assembled and mated as follows (steps a1) to e1)):
a1) first, each of the respective side-by-side modules is planar in shape as manufactured,
b1) a mold is used for shaping which is suitable for thermal deformation by bending and deformation;
c1) in such a mold, the respective side-by-side modules are arranged side by side (e.g., as in FIGS. 1, 2, 3),
d1) the plastic or composite material of the structural lining panel 105 is then placed in the mold; the mold is closed and heated to the thermoforming (also hot-forming) temperature, so that by the internal pressure and temperature of the mold, the respective side-by-side modules with the structural lining panel 105 are joined together as one piece and deformed (hot-formed) to follow the overall concave surface of the structural lining panel 105 (line), so that they are bent together,
e1) the mold is then cooled down and then opened to provide a curved, one-piece member.

A liner 106 may be added to line the side-by-side modules.

In FIG. 4, such a curved, one-piece element is shown with the respective side-by-side modules (only one of the modules, 108a, is shown) lining the globally concave side of the structural lining panel 105.

Another possibility is to line, for example, an (automotive) headliner stiffener or roof liner—as structural lining panel 105—with these respectively side-by-side modules, as follows (steps a2) to g2)):
a2) the respective side-by-side modules are produced, each in a planar form,
b2) the structural lining panel 105 is also separately manufactured in a first build-up layer and a second build-up layer, both of which are planar, which may each be referred to as a (above-called) structural wall surface,
c2) the respective side-by-side modules and the first layer setting are bonded or joined together, for example by gluing,
d2) a mold is used for the molding which is suitable for thermal deformation by bending and/or forming,
e2) in such a mold, the second layer setting is arranged in such a way that the respective side-by-side modules, which are arranged next to one another, are arranged between the first layer setting and the second layer setting,
f2) then, in the mold, the respective side-by-side modules and the first and second layer settings are all hot-formed together into a globally non-planar shape, typically a shape:
   having a globally concave face and an opposite globally convex face, such that all layers are bent together, and/or
   with at least some embossments, locally,
g2) the mold is then cooled down and then opened so as to obtain a non-planar one-piece element, possibly a curved one-piece element, which may be called: a thermally effective modular assembly.

For example, the local embossments may consist of local depressions on one side and protrusions on the opposite side, possibly interspersed with holes.

FIG. 6 shows an example of such a thermally effective modular assembly produced by steps a2) through g2) and arranged to outwardly bound an interior volume 102.

This thermally effective modular assembly includes:
the structural lining panel 105 having the plurality of structural wall surfaces 105c, 105d of moldable material assembled to form the structural unit,
the plurality of side-by-side modules, such as modules 108a, 108b, each module comprising:
   the hermetically sealed envelope 49 and/or 51 and stacked in the Z direction (oriented from the internal volume to the structural unit):
   possibly a layer 15 comprising PCM, and,
   the layer 23 comprising the thermal insulation material.

The side-by-side modules are arranged next to each other in a direction oriented to the wall surfaces, i.e., transverse to the Z direction.

Another option is as follows (steps a3)-b3)):
a3) first, the structural lining panel 105 and the respective side-by-side modules 108a to 108d are fabricated separately; each is formed into its final non-planar shape: a plurality of separate molds are used, including at least one mold for the structural lining panel 105 and one mold for the respective side-by-side modules. In each mold, the corresponding non-planar or curved shape is achieved by thermoforming. The shape of each module is adapted to follow the shape of the structural lining panel 105 on one side thereof, typically the globally concave side of the structural lining panel 105,
b3) then fixation means such as 117a, 117b are selected and the respective modules are directly fastened to the structural lining panel 105 on one side thereof, typically with the globally convex side of the respective modules facing the globally concave side of the structural lining panel, as shown in FIG. 2.

Where the direct fixation means, such as 117a, is, for example, a hook-and-loop fastener system, a series of corresponding male and female portions of hook-and-loop fasteners are respectively adhered or secured to the respective side-by-side modules 108a through 108d and the structural lining panel 105 before being secured together.

Where the direct fixation means, such as 117b, includes staples, rivets, or pins, for example, the fixation means are arranged after the respective side-by-side modules are fastened, including bonded, to the structural lining panel 105.

As shown schematically in FIG. 2, such direct fixation means may be independent pins, clips, or rivets 117b that pass through holes 121 in the respective side-by-side modules 108a through 108d and are secured (bolted or pressed) into the material of the structural lining panel 105.

The holes 121 are hermetic holes: each hole 121 is bounded by a portion of the airtight envelope 49 and/or 51 that lines a passage 124 extending through the layer containing the thermal insulation material 23, and possibly the layer 15 containing the PCM, if any. Thus, at the location of each hole 121, a portion of the airtight envelope 49 and/or 51 extends from one side of the module to the other.

In another embodiment of such fasteners, as shown in FIG. 5:
each non-planar module (labeled 108a to 108d above) is made of a thermoplastic (de)formable material and each module has hermetic holes 121 through the layer 15, the layer 23 and the airtight envelope 49 and/or 51, and,
the structural lining panel 105 has pins 122 passing through the hermetic holes 121, and wherein the pins have a free end provided with edges that are applied outwardly against the module to retain the module.

Each pin 122 may include a protrusion that protrudes from the body 105a of the structural lining panel 105 (the outer surface) and is inserted through one of the holes 121.

At a free end, the pin 122 may include a widening or pivoting edge such that an edge 122a, when engaged, holds the module against (the body 105a of) the panel in the Z direction.

The edge 122a may be considered an edge that is applied outwardly against the module to hold the module with respect to (the body of) the panel 105.

Another direct mechanical fixation between the structural lining panel 105 and at least some of non-planar modules may consist in providing the structural lining panel 105 with edges or ledges 125 (as in the example of FIG. 7) under which the module(s), such as the module 108a, may be engaged.

Held in place by the ledge(s) 125, the module(s) rest(s) on the (main portion of) the structural lining panel 105.

Preferably, the ledges 125 are disposed around the perimeter of the structural lining panel 105, on the inward side thereof.

A foam layer 119 may line and cover the side-by-side modules 108a through 108d and be secured to the structural lining panel 105, such that the foam layer 119 helps to hold the side-by-side modules on one side of the structural lining panel 105.

FIGS. 8 and 9 show two ways to fabricate a complex MCP & VIP.

In the two proposed and preferred embodiments, each module, as denoted by 108a in the example, comprises at least one closed outer envelope containing the first and second layers of materials 15/23 and consisting of at least one plastically deformable sheet or film that is peripherally sealable to itself (thermally and/or chemically) and impermeable to the material 23 and to air. The peripheral seal is designated 49a, 49b in FIG. 8.

Precisely:
either there is only one envelope 49 enclosing (completely covering) the thermal insulation material 23 and the MCP 15 (if present), which are arranged one above the other, with the thermal insulation material 23 on the outside and the MCP 15 on the inside, as shown in FIG. 8,
or there is the first envelope 49 enclosing (fully covering) the thermal insulating material 23, but also a second envelope 51, possibly a film, covering the MCP 15, at least on one side of the first envelope 49, as shown in FIG. 9.

It should be noted that two layers of a first PCM and a second PCM could be arranged on each side of the thermal insulation material 23.

The film(s) of the envelope(s) 49 and/or 51 may each be made as a multilayer film of polymeric films (PE and PET) and aluminum in the form of, for example, laminated (film having a thickness of about ten micrometers) or metallized (vacuum coating of a film of a few tens of nanometers) film. Metallization can be applied to one or both sides of a PE film, and several metallized PE films can be joined together to form one film. Sample film structure: —PE inner seal, approx. 40 μm—Vacuum metallization Al, approx. 0.04 μm—PET outer layer, approx. 60 μm.

Let us consider now FIGS. 13,14,17 which, in addition to FIGS. 1-2, show a part of the vehicle body 103 which includes a roof unit 103a arranged at the top of the side wall columns, respectly front 110a and rear 110c, with possibly intermediate ones as well, 110b.

The roof unit comprises a solid roof frame 200 the corners of which are delimited by the front and rear side wall columns.

More precisely, the roof unit and its solid frame 200 comprise:
connecting the side wall columns tranversally, front and rear cross members, also called cross beams or cross frames, 202 and 204, and possibly an intermediate cross frame as well, 214, respectly, and,
connecting the side wall columns laterally, longitudinal frame members, 206,208.

The roof unit comprises the ceiling, or roof outward skin panel, 210 as well.

The roof outward skin panel 210 and possibly at least a part of the solid roof frame 200 is/are outlining an external size and external shape of the vehicle.

As it has already been understood from the foregoing explanations, the so-called “external shape” defined above will typically be:
the roof line, for the roof outward skin panel and possibly a part of the roof frame, and
the accent line, for the door outward skin panel and possibly a part of the door frame, which accent line has an influence on the base line as well.

During production of the vehicle, and as an alternative to the solution illustrated in FIGS. 1,2, in which the outward skin panel 210 can be lowered from above onto the solid frame 200, the roof outward skin panel 210 may be inserted through a front or rear window opening and, in an upwards movement, brought up to the points for connecting it to the longitudinal frame members 206,208 and/or the cross members.

In such a case, the outward skin panel 210 may have longitudinal edges which are applied against the respective inward surfaces of the longitudinal frame members 206,208.The outward skin panel 210 and the solid frame 200 are anyway permanently joined together at seams, e.g. by adhesive bonding and/or welding.

The front cross member, rear cross and longitudinal frame members, together with the intermediate cross frame (if any), delimit:
the non-planar surface S1 of the roof unit) 103a which is covered by the roof outward skin panel 210, and,
at least one volume (two if the intermediate cross frame exists) which extend(s) between:
inwardly, the passenger cabin 102,
outwardly, the roof outward skin panel 210,
frontally, the front cross member 202, and,
rearwardly, the rear cross member 204.

The plurality of modules, 108j-108l in the example, extend within said at least one volume, which includes two volumes referenced 196a,196b in FIG. 17 and one of which may define the above-mentioned front or rear window opening through which the roof outward skin panel 210 may be disposed to be directly fastened to the corresponding body part.

As the door outward skin panel 182, the outward skin panel 210 may be metal, composite or polymer. Each may be preferably one part and may e.g. be a shaped part of metal such as a pressure die casting.

In FIG. 17, the embodiment does not strictly illustrate the section XVII-XVII, because the modules 108j,108l:
do not have the lines 198 of curvature, and
do not extend under the front and (possibly) intermediate cross beams.

In this embodiment, the (or each) module, such as 108j,108k,108l, is (respectively) engaged within a so-called volume, such as referenced 196a,196b, extending:
longitudinally between two successive cross beams,
transversally, between the two longitudinal frame members 206,208.

The(each) volume 196a,196b has vertically a thickness equal to the height or thickness h of the cross beams.

Thus, in this embodiment, each module occupies a free space and does not add an overthickness below the cross beams.

As it may be understood notably from FIG. 1,2 or 17, the structural lining panel 105 is lining the front cross member 202, rear cross member 204, and longitudinal frame members 206,208, and said at least one module is directly fastened, as above-mentioned, to the structural lining panel 105.

A soundproofing member or layer (one or more) 199 (see FIG. 17) may be interposed between the at least one module and said roof outward skin panel 210.

One or more soundproofing member or layer 199 may be arranged between the module set and the roof outward skin panel 210.

As an alternative, the structural lining panel 105 might comprise or integrate a soundproofing layer 199, as a one-piece unit; see FIG. 6.

Surprisingly, the addition of a soundproofing member or layer to the thermal insulation effect got by the modules under vacuum will allow various disturbing sounds to be absorbed around the passenger cabin 102, and should improve the comfort level the vehicle.

Below are now successive features in relation to the present invention and which may be considered independently from each other and in any combination.

The vehicle body 103 locally defines a roof unit 103a extending above the passenger cabin 102, and the structural lining panel 105 is directly fastened with the vehicle roof unit 103a by the fixation means 116.

To enter or exit the passenger cabin, the vehicle body comprises a door unit 103b which includes:
a door outward skin panel 182, and
a solid frame or skeleton 180 articulated on a base (such as 184 in FIG. 12) of the body 103 from which erects one of the side wall columns.

The structural lining panel is directly fastened with the door unit 103b (may be the solid frame 180) by the fixation means 116.

The structural lining panel 105 integrates an armrest 123. So, it has a non-planar shape.

The structural lining panel 105 and the side-by-side modules 108a to 108i
(their envelopes) may each be made of a thermoplastically formable material directly fastened together, so that the structural lining panel and the side-by-side modules will each have matching non-planar shapes; see for example FIGS. 15-16.

On that matter, FIGS. 15-16 illustrate the embodiment of a structural lining panel 105 to be used for lining a roof unit 103a and which is viewed respectively:
from inward (viz. the passenger cabin 102) and,
from outward (the outdoor environment 109 or the ceiling 210).

The modules are individually adhesively bonded to the outward non-planar surface S2 of the structural lining panel 105.

Such a structural lining panel 105 may notably have transversal depressions 186,188,190, viewed from inward, and lateral edges 192,194.

Viewed from outward (FIG. 16), the lateral edges 192,194 flare downwards.

The transversal depressions 188,186,190 are intented to be disposed facing from above the front, rear, and intermediate cross members, 202,204,214, respectively.

The lateral edges 192,194 are intented to be disposed facing from above the longitudinal frame members 206,208, respectively.

Anyway, the structural lining panel 105 has a non-planar shape, and both the structural lining panel and the side-by-side modules, such as referenced 108j,108k,108l in FIG. 16, have matching non-planar shapes.

Lines 198 in FIG. 16 show that the side-by-side modules each have a non-planar shape.

In other words, the non-planar surfaces of said plurality of modules individually fit with the non-planar surface S2 of the structural lining panel 105.

As an alternative (see FIGS. 12,13,21-24,26-27), the non-planar surface of any so-called module may fit with the non-planar surface S1 or S3 of the vehicle body part.

This may be considered as valuable in terms of security, efficiency and easiness of manufacturing.

Since the body of a vehicle may typically be more aggressive regarding the risk of altering a so-called module, and notably puncturing the envelope 49 or 51, it may really be considered as a safe solution to directly fasten any non-planar module to the selected body part before directly fastening the structural lining panel 105 to said selected body part, with then no direct fastening between the structural lining panel 105 and any module.

If so directly fastened to the vehicle body part only, any module will be preferably fastened by a chemical bonding, preferably an adhesive bonding, even if a mechanical direct fastening, as previously detailed, is not strictly excluded. It

Since such a mechanical direct fastening would still remain more or less hazardous, embodiments specifically refer to directly gluing at least one non-planar module to the non-planar surface of the body part, viz.:
a) the surface S1 of the roof unit 103a, in the examples illustrated in FIGS. 21, 24 and 26 and,
b) the surface S3 of the 180 of a door unit 103b in the examples illustrated in FIGS. 12 and 27.

In case b), the door frame 180 of the door unit has an opening 201 passing therethrough.

The direct fastening of the module, such as 108m or 108n, comprises exclusively a chemical bonding between the airtight envelope 49 and the door frame, by means of a sticky joint 220 sticked to the airtight envelope and to the door frame, around the opening 201.

A sticky joint 220 will anyway preferably be an elongated strip or band of an adhesive material having the shape of a cord or a rope-like joint. To provide the module with an anti-vibration effect and a mechanical protection effect:
the section of the cord or rope will preferably prevent the module to be in physical contact with either the structural lining panel 105 or the vehicle body, which it is fasten to, and/or,
the sticky joint 220 will be an adhesive rubber cord type seal, possibly made with EPDM.

The sticky joint 220 will preferably have a section of at least 4 mm², and advantageously 6 mm².

Depending on the embodiment of door unit 103b:
either, as illustrated in FIG. 12, the door frame, also called frame part, 180 includes a window frame 180a adapted to surround a window 203 of the vehicle, while the outward skin panel 182 is a skin covering a base part 180b of the door frame through which pass(es) the opening(s) 201,
or, as illustrated in FIG. 27, the door frame 180 includes only the base part 180b, which may be still called frame part since it has one or more opening(s) 201 passing therethrough. In this case, the window frame, referenced 182a adapted to surround a window 203 of the vehicle is a part of the outward skin panel 182 which extends upwardly above a skin panel part 182b outwardly covering the frame part 180/180b.

The sticky joint 220 may especially be sticked on the envelope 49 (or 51), at the periphery 490 of the envelope 49 (or 51), where the material of the envelope is chemically bonded, such as welded, on itself, around the central part of the envelope where the insulating material 23 is arranged.

At this periphery, there is no insulating material 23.

This periphery may extend on all the perimeter of the envelope.

The sticky joint 220 may especially be an adhesive strip.

As an alternative, the sticky joint 220 may adhere first on the non-planar surface of the frame part and then the(each) module may be applied against the sticky joint 220.

Anyway, once the chemical bonding between the airtight envelope 49 and the door frame, by means of the sticky joint 220 sticked to both the envelope 49 (or 51) and the frame part 180b, around the opening(s) 201, the structural lining panel 105 may be directly fastened to the frame part 180b by the fixation means 116.

The structural lining panel 105 is not directly fastened to any so-called module, such as those referenced 108m or 108n in the example.

Let us turn now to the embodiments as illustrated in FIGS. 19 to 26.

Except the embodiment corresponding to FIG. 22, all these embodiments detail respective solutions for adhesively bonding a so-called module to either the structural lining panel 105 or a body part, which is a roof unit in these examples (but might be a frame part of a door unit).

All these solutions are valuable, since they provide a low risk of puncturing the airtight envelope of the module.

In the embodiment corresponding to FIGS. 19 & 20, a layer 205 of adhesive material is directly applied on the respective airtight envelopes of the modules, respectively 108l and 108j, and the outward non-planar surface S2 of the structural lining panel 105, so that they are directly and adhesively bonded together.

Frontally (in FIG. 19), rearwardly (in FIG. 20), each airtight envelope of the respective modules is arranged at a distance from the front cross member 202 and rear cross member 204, respectively.

Above, the outward skin panel (210 in this example) covers all the modules at a distance from each module, respectively 108l and 108j.

If not empty, the volume (or air gap) 207 so arranged upwardy above each module may be occupied by one of a foam layer, a felt layer and a soundproofing layer not aggressive for the envelope 49.

As in any embodiment, the fasteners 116 are arranged at a distance from each module, so that there is no interference therebetween.

At least some of the fasteners 116 are passing through both:
the structural lining panel 105, and,
one of the front cross member 202 and rear cross member 204.

The adhesive layer 205 covers a major part of the non-planar surface of the module, including the envelope.

“Major” means, in this specification, extending on more than 50%, and preferably more than 70%, of the surface on which the adhesive layer is applied, presently the non-planar surface of the module.

In the embodiment corresponding to FIG. 21, one of a foam layer, a felt layer and a soundproofing layer 209 is directly interposed between a module (108l in the example) and the body part: the outward skin panel (210 in this example)

Further, two layers 205a,205b of an adhesive material are further directly applied respectively:
between said body part (the outward skin panel (210 in this example) and said one of a foam layer, a felt layer and a soundproofing layer 209, and,
between the layer 209 and the airtight envelope of a module (108l in the example).

Consequently the module is upwardly directly fastened to the body part while being downwardly separated from the structural lining panel 105 by a gap 222 which is presently an empty volume, or air gap.

The above-cited direct fastening 116 is still illustrated.

The layer 209 is a mechanically protective layer for the envelope which may extend between the envelope and the front cross member 202 or rear cross member 204. An edge 209a of the layer 209 may provide such a protection.

In the embodiment corresponding to FIG. 22, one of a foam layer, a felt layer and a soundproofing layer 209 adheres directly to the body part: the outward skin panel 210 in this example.

The mechanical protection of any module, such as 108l, arranged close to the body frame (one of the cross members (202) in this example), is provided by an edge 125a of a tab or ledge 125 which mechanically directly fasten every module to the structural lining panel 105, exclusively.

The tab or ledge 125 is an extension, so a part of the structural lining panel 105.

The edge 125a defines a cover interposed between the module and the body part.

In the embodiment corresponding to FIGS. 23 and 24, a sticky joint 220 is sticked to the airtight envelope and to the body frame, to directly fasten every module to the body frame, exclusively.

The sticky joint 220 defines an adhesive element:
which is interposed in this case between the airtight envelope and the body frame (or the outward skin panel 210), and
which mechanically protects the airtight envelope.

On a roof unit, one or more sticky joints 220 may especially be sticked to at least one of the front cross member 202, rear cross member, 204, longitudinal frame members 206,208, and outward skin panel 210.

A gap 222 separates each module, such as 108l or 108j in this example, from the structural lining panel 105 which is directly fastened to the roof frame 200, exclusively, by the so-called fasteners 116 arranged away from any module.

In the embodiment corresponding to FIG. 26, the solution is common with the embodiment corresponding to FIG. 21, because the so-called module may be called a “module set” which further includes one of a foam layer, a felt layer and a soundproofing layer, 209, so that said one of the foam layer, the felt layer and the soundproofing layer:
is interposed between the airtight envelope of a so-called of module and said vehicle body part (especially the roof frame 200 in the example), and,
is adhesively bonded by a layer 205a of an adhesive material interposed between the vehicle body part and said one of the foam layer, the felt layer and the soundproofing layer.

In this embodiment, a layer 205b of an adhesive material is further directly applied between the layer 209 and the airtight envelope of a module (108l in the example).

Furthermore, a gap 222 separates each module, such as 108l in this example, from the structural lining panel 105 which is directly fastened to the roof frame 200, exclusively, by the so-called fasteners 116 arranged away from any module.

As above-explained, the adhesive layers, 205, 205a, 205b are different from the sticky joint 220 in that each so-called layer covers:
either a so-called major part of the non-planar surface of the module, including the envelope (adhesive layers 205, 205b),
or a so-called major part of the surface of said one of a foam layer, a felt layer and a soundproofing layer, 209 (adhesive layers 205a).

This is important because it should be considered as effective in terms of both a mechanical protection effect and a sound absorbing effect that said one of a foam layer, a felt layer and a soundproofing layer, 209, has a broad adherence surface.

It may noted from the above that, if a module is adhesively directly fastened to a body part, a gap 222, will usefully be interposed between said module and the outward skin panel 105, to integrally keep the airtight envelope away from the outward skin panel.

The gap 222 will be either an air gap or a gap filled with at least one of a foam layer, a felt layer and a soundproofing layer, 209.

Such a layer 209:
will have, on a major part of its surface, a direct fastening with the outward skin panel, for example by an adhesive bonding, and,
will have no direct fastening with the airtight envelope 49.

The embodiment corresponding to FIG. 25 is different from the solution corresponding to the preceding embodiment (FIG. 26) in that said one of a foam layer, a felt layer and a soundproofing layer, 209:
does not adhere to the vehicle body part (especially the roof frame 200 in the example), but
is applied against (in contact with) the roof frame 200 or the door frame 180b if a door unit is concerned.

In the embodiment corresponding to FIG. 25 a layer 205 of adhesive material is directly applied on the (or each) airtight envelope of the module and the outward non-planar surface S2 of the structural lining panel 105.

FIG. 18 illustrates another application of the thermal insulation approach by means of under vacuum modules: providing a structural lining panel 105 adapted for lining one of the front door post 110a, middle door post 110b or rear door post 110c with one least one so-called module, such as the one referenced 108m in FIG. 18.

Two structural lining panels 105 so equipped may be clamped from inward around the middle door posts 110b illustrated in FIG. 14.

Another feature is further concerned in relation to the present problem of managing comfort in a passenger compartment 102.

Using an auxiliary heater may be useful in that matter.

Consequently, FIGS. 29 and 30 each shows a schematic and partial sectional view through a cladding in the form of an embodiment of the inward cladding 104 for the passenger compartment 102 of the motor vehicle.

In this solution, the vehicle comprises at least one temperature control element 224 by means of which the inward cladding 104 or the passenger compartment 102 can be tempered, in particular heated.

The temperature control element 224 may be in the form of a temperature control layer which can be operated electrically by means of an electric circuit 226a,226b,226c.

The temperature control element 224 may be designed as a heating layer. However, the temperature control element can be an electrical resistance element, a Positive Temperature Coefficient (PTC) thermistor, a radiant panel or an element operating by Peltier effect, for example. If a Peltier element is used, for example, it would thus in principle be conceivable to use a cooling layer or an optionally heatable or coolable layer as the temperature control element. For a PTC thermistor, powdered metal oxides may be used.

As a useful solution, it is thus presently proposed:
that the vehicle further comprises an electric circuit 226a,226b,226c, and,
that a so-called module set further includes a temperature control element 224 connected to the electric circuit 226a,226b,226c, the temperature control element 224 being:
   either interposed between the structural lining panel 105 and the passenger cabin 102,
   or interposed between said part (103a or 103b) of the vehicle body and the structural lining panel 105.

In the second hypothesis, the or each temperature control element 224 will then be adhesively bonded to the structural lining panel 105, while being spaced apart from the vehicle body 103a or 103b.

The or each temperature control element 224 is anyway interposed between a so-called module (referenced 108a in FIGS. 29 and 30) and the passenger cabin 102.

The or each temperature control element 224 may consist in a layer covering, inwardly, the envelope 49 or 51 of a module.

To make the temperature control element 224 operational as an auxiliary tempering system, the vehicle may comprises a control device 228 which can recognizes at least the states “ON” and “OFF” on the above-cited electric circuit, it being possible to actuate the temperature control element 224 by means of a corresponding relay 229.

The electric circuit is electrically connected to a common source of power (+). A power signal may thus circulate in the temperature control element 224, connected to ground 232, in order to ensure that the electric tempering system is operational.

To make a plurality of temperature control elements 224 operational:
each temperature control element 224 will be connected to one of the branches 226a,226b,226c of the electric circuit, and,
the control device 228 will to actuate the respective temperature control elements 224 individually by means of the corresponding relays 229.

One or a series of control signals can be transmitted from the control device 228 to the relay(s) 229 by means of a vehicle bus, such as the CAN bus or LIN bus, for example.

Even if not illustrated in FIG. 29, and as does the branch 226a, each branch 226b,226c includes a temperature control element 224.

Ground 232 is common to all of the temperature control elements 224.

Via the branches 226a,226b,226c which are electrically connected to a common source of power (+), a power signal may circulate in the temperature control elements 224.

Two arrangements of the or each temperature control element 224 are proposed:

FIGS. 29 and 30 respectively illustrate both arrangements and show only one temperature control element 224, the arrangement of which is detailed below.

In the first arrangement (FIG. 29), the module 108a is outwardly directly fastened to the structural lining panel 105. And, a decorative layer 106 is interposed between the temperature control element 224 and the passenger cabin 102.

To be operational as an auxiliary tempering system, the temperature control element 224 and the above electric circuit are included in a temperature control device 225 of the motor vehicle adapted to temper the temperature in the passenger cabin 102.

The temperature control device 225 further comprises a heating, ventilation, and air conditioning (HVAC) device 230, for supplying an airflow in the passenger cabin 102.

The decorative layer 106 is permeable to airflow and/or an air gap, or a conduit for air flow, is interposed between the temperature control element 224 and the decorative layer 106. The decorative layer 106 may be fabric, or a perforated carpet.

As a consequence, inwardly, viz. on the side directed to the passenger cabin 102, the temperature control element 224 is arranged to be exposed to an air flow (AIR) which may at least partially be supplied by the HVAC device 230.

In the second arrangement (FIG. 30), the temperature control element 224 is interposed between the vehicle body part (103a or 103b) and the structural lining panel 105.

On its two opposite sides, the temperature control element 224 is in physical and thermal contact with, and adhesively bonded to, the module 108a and the structural lining panel 105, respectively.

Consequently, the module 108a is considered as including the temperature control element 224, which means the module 108a is, at least on a part of its non-planar surface, directly fastened to the structural lining panel 105 by means of the temperature control element 224. On the remaining part of the surface, the module 108a may directly adhere to the structural lining panel 105.

When powered trough the electric circuit, the or each temperature control element 224 can accordingly modify the temperature of the structural lining panel 105.

In the passenger cabin 102, the volume of which is in thermal contact with the structural lining panel 105, such a modification of temperature improves the comfort of the passenger who feels the modification.

As above-mentioned what precedes may indifferently be used in cars, but also, for example, in buses, driver's cabs of trucks or mobile homes.

Since aeronefs are also concerned, FIG. 31 illustrates an aircraft 240, a door 103b of which or a fuselage 103a of which is provided with any of the above features adapted to manage comfort in the passenger cabin 102.

In that matter, it will be understood from the foregoing that, if the vehicle body part 103a comprises a fuselage unit including an outward skin panel 210 and a (structural) frame delimiting a surface outwardly covered by the outward skin panel 210:
a structural lining panel 105 will be inward lining the frame, and,
if a plurality of modules, such as 108a, 108b, are directly fastened to the structural lining panel 105, the non-planar surfaces of said plurality of modules will individually fit with the non-planar surface S2 of the structural lining panel.

The above structural frame may be substantially the same as the frame 200, since, in a typical aircraft construction (such as a semi-monocoque one), a series of circonferential beams (often called “frames”) in the shape of the fuselage cross sections are held in position on a rigid fixture. These circonferential “frames” are joined with lightweight longitudinal elements called stringers. These are in turn covered with an outward skin, which may be made of sheet aluminum, attached by riveting or by bonding with special adhesives. The skin comprises a plurality of adjacent skin panels.

1. A vehicle having a passenger cabin, the vehicle comprising a vehicle body part and, interposed between the passenger cabin and the vehicle body part:
a structural lining panel which is inwardly lining said part of the vehicle body, the structural lining panel having a outward non-planar surface and containing at least one of a polymer material and a natural material, fixation means to fasten the structural lining panel to said part of the vehicle body; and
a module set comprising a plurality of modules, each module extending in a non-planar surface and being interposed between the vehicle body part and the structural lining panel, each module comprising:
an airtight envelope and, enclosed under vacuum within the airtight envelope:
a layer comprising a thermally insulating material, the modules being arranged in a direction oriented according to the non-planar surface of the structural lining panel or an inward non-planar surface of the vehicle body part,
said module set being directly fastened to one of the structural lining panel and said vehicle body part, only.

2. The vehicle according to claim 1, wherein the vehicle body part locally defines a roof unit extending above the passenger cabin, and the structural lining panel is fastened with the roof unit by the fixation means, with:
either no direct fastening of said module set to the structural lining panel,
or no direct fastening of said module set to the roof unit.

3. The vehicle according to claim 1, wherein:
the vehicle body part comprises a door unit to enter or exit the passenger cabin and which includes a door outward skin panel, and
the structural lining panel is directly fastened to the door unit by the fixation means, with:
either no direct fastening of said module set to the structural lining panel,
or no direct fastening of said module set to the door unit.

4. The vehicle according to claim 1,
further comprising a foam layer fastened to the structural lining panel and applied against the modules, such that the modules are interposed between the structural lining panel and the foam layer, and/or
further comprising a liner inwardly lining the structural lining panel and to which the structural lining panel is fastened, so that the modules are interposed between the liner and the structural lining panel.

5. The vehicle according to claim 1,
wherein the vehicle body part comprises a roof unit including an outward skin panel, a front cross member, a rear cross member, and longitudinal frame members delimiting a surface covered by the outward skin panel, and,
wherein at least one volume extends between:
inwardly, the passenger cabin,
outwardly, the roof outward skin panel,
frontally, the front cross member, and,
rearwardly, the rear cross member,
at least one of said plurality of modules extending within said at least one volume.

6. The vehicle according to claim 1,
wherein the vehicle body part comprises one of a roof unit and a fuselage unit including a frame having an inward non-planar surface and delimiting a surface outwardly covered by the outward skin panel,
wherein the structural lining panel is lining the frame,
wherein the plurality of modules are directly fastened to the structural lining panel, and,
wherein the non-planar surfaces of said plurality of modules individually fit with the non-planar surface of the structural lining panel.

7. The vehicle according to claim 1,
wherein the vehicle body part comprises a roof unit including an outward skin panel, a front cross member, a rear cross member, and longitudinal frame members having respective inward non-planar surfaces and delimiting a surface covered the outward skin panel,
wherein the structural lining panel is lining the front cross member, rear cross member, and longitudinal frame members, and,
wherein the plurality of modules are directly fastened to at least one of the front cross member, rear cross member, and longitudinal frame members, and,
wherein the respective non-planar surfaces of the plurality of modules and of at least one of the front cross member, rear cross member, and longitudinal frame members fit together.

8. The vehicle according to claim 1, wherein said module set further includes one of a foam layer, a felt layer and a soundproofing layer, so that said one of the foam layer, the felt layer and the soundproofing layer:
is interposed between the airtight envelope of at least one of the plurality of modules and said vehicle body part, and,
is adhesively bonded by a layer of an adhesive material interposed between the vehicle body part and said one of the foam layer, the felt layer and the soundproofing layer.

9. The vehicle according to claim 1, wherein said direct fastening of the module set comprises a chemical bonding between the modules and the vehicle body part, by means of:
a sticky joint sticked to the vehicle body part and each the modules, or,
a series of sticky joints sticked to the vehicle body part and the respective modules.

10. A vehicle having a passenger cabin and comprising:
a part of a vehicle body including an outward skin panel outlining an external shape of the vehicle and,
a structural lining panel inwardly lining the outward skin panel and containing at least one of a polymer material and a natural material, the structural lining panel having a non-planar surface,
fixation means to directly fasten the structural lining panel to the vehicle body part,
a module set including at least one module extending in a non-planar surface, the at least one module comprising:
an airtight envelope and, enclosed under vacuum within the airtight envelope:
a layer comprising a thermally insulating material,
wherein said module set is directly fastened to said structural lining panel, and,
wherein said module set is further indirectly fastened to said vehicle body part, via said fixation means.

11. The vehicle according to claim 10, wherein the module set includes a plurality of said modules arranged side by side in a direction oriented according to the outward surface of the structural lining panel.

12. The vehicle according to claim 10, further comprising a liner inwardly lining the structural lining panel, and wherein:
the liner is directly fastened to the structural lining panel, and,
the module set is interposed between the liner and the structural lining panel.

13. A vehicle having a passenger cabin and comprising:
a part of a vehicle body including an outward skin panel outlining an external shape of the vehicle, the vehicle body part having an inward non-planar surface,
a structural lining panel which is inwardly lining the outward skin panel, the structural lining panel containing at least one of a polymer material and a natural material, and having a outward non-planar surface,
fixation means to fasten the structural lining panel to the vehicle body part, a module extending in a non-planar surface, the module comprising:
an airtight envelope and, enclosed under vacuum within the airtight envelope:
a layer comprising a thermally insulating material, and,
wherein said module is arranged between the structural lining panel and the outward skin panel, and
wherein said module is directly fastened to the vehicle body part, only.

14. The vehicle according to claim 13,
wherein the outward skin panel is a part of a roof unit of the vehicle having a non-planar surface,
wherein the roof unit further includes a front cross member, a rear cross member, and longitudinal frame members delimiting a frame covered by the roof outward skin panel and having a non-planar surface,
wherein the structural lining panel is lining the front cross member, rear cross member, and longitudinal frame members,
wherein said module is directly fastened to at least one of the front cross member, the rear cross member, the longitudinal frame members and the roof outward skin panel, and,
wherein the non-planar surface of said module fit with a part of the non-planar surface of at least one of the roof frame and the outward skin panel.

15. The vehicle according to claim 13,
wherein the outward skin panel is a part of a door unit of the vehicle,
wherein the door unit further includes a frame part having an inward non-planar surface and which is covered outwardly by the outward skin panel and inwardly by the structural lining panel,
wherein said module is directly fastened to the frame part, and,
wherein the non-planar surface of said module fit with a part of the inward non-planar surface of the frame part.

16.The vehicle according to claim 14,
wherein said module further includes one of a foam layer, a felt layer and a soundproofing layer chemically bonded with the airtight envelope, so that said one of the foam layer, the felt layer and the soundproofing layer is interposed between the airtight envelope and said vehicle body part, and,
wherein said direct fastening of the module is a chemical bonding between:
said one of the foam layer, the felt layer and the soundproofing layer, and
at least one of the frame and outward skin panel.

17. The vehicle according to claim 15,
wherein said module further includes one of a foam layer, a felt layer and a soundproofing layer chemically bonded with the airtight envelope, so that said one of the foam layer, the felt layer and the soundproofing layer is interposed between the airtight envelope said door frame, and,
wherein said direct fastening of the module is a chemically bonding between:
said one of the foam layer, the felt layer and the soundproofing layer, and
the frame part.

18. The vehicle according to claim 13,
wherein the frame part has an opening passing therethrough,
wherein said direct fastening of the module comprises a chemical bonding between the airtight envelope and the frame part, by means of a sticky joint sticked to the airtight envelope and to the frame part, around the opening.

19. The vehicle according to claim 16, wherein the chemical bonding between the airtight envelope and said one of the foam layer, the felt layer and the soundproofing layer comprises a layer of an adhesive bonding covering a major part of the non-planar surface of the module.

20. The vehicle according to claim 17, wherein the chemical bonding between the airtight envelope and said one of the foam layer, the felt layer and the soundproofing layer comprises a layer of an adhesive bonding covering a major part of the non-planar surface of the module.

21. The vehicle according to claim 13,
wherein a gap is interposed between said module and the outward skin panel, to integrally keep the airtight envelope away from the outward skin panel, and
wherein the gap is either an air gap or a gap filled with one of one of a foam layer, a felt layer and a soundproofing layer.

22. The vehicle according to claim 10,
further comprising an electric circuit, and
wherein the module set further includes a temperature control element connected to the electric circuit, the temperature control element being:
either interposed between the structural lining panel and the passenger cabin,
or interposed between said part of the vehicle body and the structural lining panel.
